(19) United States
(12) Patent Application Publication
(10) Pub. No.: US 2026/0350017 A1
(43) Pub. Date: Nov. 5, 2026

(54) ADAPTIVE CONTEXTUAL DATA INTEGRATION

(71) Applicant: Stripe, LLC, South San Francisco, CA (US)

(72) Inventor: Ashwin GOYAL, Bengaluru (IN)

(21) Appl. No.: 19/197,909

(22) Filed: May 2, 2025

(51) Int. Cl. G06F 16/2457

(52) U.S. Cl. CPC G06F 16/24575

(57) ABSTRACT

Aspects of the subject technology performs matching contextual items to a contact event and updating a communication content to link the contextual information for the matched contextual item to a group of relevant words selected from the communication content. The updated communication content is provided to another device for interacting with the matched contextual items.

### TECHNICAL FIELD

The present description generally relates to connecting contextually relevant information from one data source to a communication record and further providing a user interface for accessing the contextually relevant information.

### BACKGROUND

Agents of a service provider may access a communication record in conjunction with communicating with a user of the service. The communication record may contain, for example, questions or concerns raised by the user of the service. The agent may need to cross-reference historical data or other data stored in databases in relation to the user and/or the service provided to the user to resolve the questions or concerns of the user. This presents a challenge because the cross-referenced data may be inconsistently presented to the agent, may be stale, or may be confusing or substantively inconsistent.

### BRIEF DESCRIPTION OF THE DRAWINGS

Certain features of the subject technology are set forth in the appended claims. However, for the purpose of explanation, several embodiments of the subject technology are set forth in the following figures.

FIG. 1 illustrates an example system environment in which the subject technology may be implemented, in accordance with one or more embodiments.

FIG. 2 depicts an example electronic device that may implement the subject technology, in accordance with one or more embodiments.

FIG. 3 illustrates a lane diagram for processing communications to determine contextually relevant supplemental information, in accordance with one or more embodiments.

FIG. 4. illustrates an example interface for viewing a communication with contextually relevant information, in accordance with one or more embodiments.

FIG. 5. illustrates an example interface for viewing a communication with contextually relevant information, in accordance with one or more embodiments.

FIG. 6 illustrates an example interface for viewing a communication with contextually relevant information, in accordance with one or more embodiments.

FIG. 7 illustrates an example user interface for managing agent notes, in accordance with one or more embodiments.

FIG. 8 illustrates an example user interface for a context log, in accordance with one or more embodiments.

FIG. 9 illustrates a flow diagram of an example process for determining contextually relevant context items for a contact event, in accordance with one or more embodiments.

FIG. 10 illustrates a flow diagram of an example process for receiving contextual information for a contact event, in accordance with one or more embodiments.

FIG. 11 depicts an example electronic system with which aspects of the present disclosure may be implemented, in accordance with one or more embodiments.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other embodiments. In one or more embodiments, structures and components are shown in block diagram form in order to avoid obscuring the concepts of the subject technology.

An agent of a product services organization can obtain a communication relating from contact events between users of the products or services of the organization seeking support in the usage of the product or services. Content relevant to the communication and which would aid the agent in resolving concerns raised by the users may be available from one or more datasets. Aspects of the subject technology can obtain the relevant information from the one or more other datasets, determine one or more terms in the communication corresponding to the relevant information, and associate the relevant information to the one or more terms. In some aspects, the one or more terms can be displayed in a manner that marks or indicates them as being associated with relevant information from the one or more other datasets. In some implementations, when a mouse pointer, for example, is hovered over the marked terms or clicked once on the marked terms, a pop-up box can be displayed, overlaid over the communication, which provides context corresponding to the relevant information. Some implementations may provide, within the context, links to external data sources for the user to obtain more detailed information for the relevant information. Some implementations may also include displaying an overview of other more generally relevant information from the one or more other datasets, inserted into or displayed in line with the communication. In such instances, the overview of other relevant information may be relevant to the information in the first dataset in a more general way (e.g., associated with an account or entity information of the user) than the linked relevant information which may be more relevant to the linked one or more terms (e.g., that indicate a specific issue raised by the user to the agent).

Some aspects of the subject technology provide a management interface for maintaining the relevant information in the one or more other datasets. The management interface, for example, may provide access to and editing capabilities to insert, edit, or delete records corresponding to the relevant information. The management interface may also be used for recursive training of a language model that is used in conjunction with the subject technology.

Aspects of the subject technology may utilize the relevant information and the communication stored in a first dataset to update the communication stored in the first dataset to include the relevant information or to include information associated with the relevant information, as a part of the first dataset.

Some implementations of the subject technology may be understood with respect to particular examples described herein. It should be understood that such examples are not meant to be limiting, but are provided for explanatory purposes.

In one implementation, for example, agents of an organization may be tasked to support users of a product or service of the organization. A user may contact an agent for support, for example, through a communication channel, such as a chat support tool, email, text service, voicemail, or by phone. A first dataset can be created to store communication content related to the contact event. For example, a transcript of a voicemail from the user can be created and stored in the first dataset. Or in another example, an email from the user or email dialogue between the user and the agent can be stored in the first dataset. In another example, a phone call between the user and the agent can be transcribed in real-time using transcription tools, and a record of the phone call stored in the first dataset.

When available, records from one or more other data stores related to the contact event may be obtained and analyzed in association with the communication content from the record of the contact event (e.g., a transcript of the communication) to dynamically determine if any contextually relevant information from the records from the one or more other data stores is available. If so, the communication content from the contact event may be adapted to dynamically include the contextually relevant information. The one or more other data stores may be dynamically correlated to the contact event, for example, by extracting organization information, account information, or contact information from the contact event and utilizing that information to obtain a subset of records from the one or more other data stores. The subset of records from the one or more other data stores can be used in association with the communication content from the contact event by a language model may to determine which ones of the subset of records are contextually relevant to the communication content and to further determine which words of the communication content from the contact event are selected to be dynamically associated with the contextually relevant information. In some implementations, the contact event record can be dynamically updated in the first datastore to reflect the adaptive contextually relevant information. The system can display to the agent the adapted contact event information from the first data store which includes the contextual information. The agent can then utilize that information to better resolve the underlying concern which prompted the user to contact the agent for service or product support.

In some implementations, such as in the current example, the contact event may be part of an asynchronous dialogue, such as a text or email exchange. In such instances, each new email or text can be analyzed in association with the records from the one or more data stores to determine if contextually relevant information can be included. And if so, the record of the exchange can be updated to adaptively include the contextually relevant information, in some instances dynamically adding additional contextually relevant information to the contact event after a previous part of the exchange resulted in other previously added contextually relevant information.

Thus, aspects of the subject technology advantageously dynamically associate contextually relevant information from one or more data stores to a communications record to help a service provider more quickly access relevant contextual information to the content of the communications with less confusion and less noise. Aspects of the subject technology also adapt the communications record to include the contextual information. Thus, aspects of the subject technology advantageously reduce resources by reducing the data transmission resources, such as energy and time associated with data transmission by reducing the number of queries that an agent would need to execute without the subject technology. Aspects of the subject technology also reduce the time needed to process support requests, thereby freeing system resources or reducing the need for as many parallel resources to address such requests.

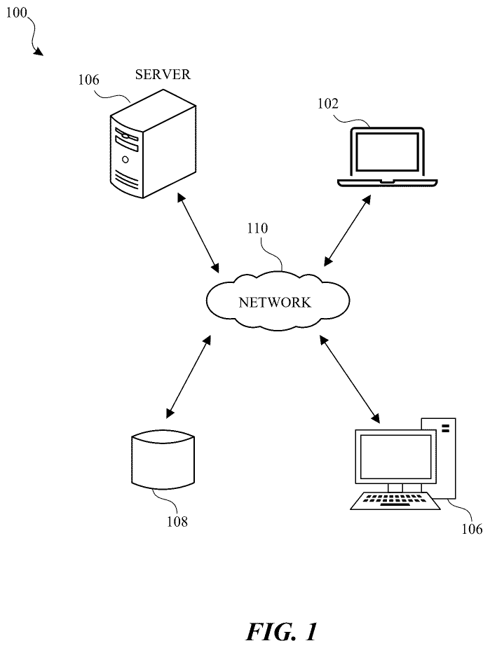

FIG. 1 illustrates an example system and network environment 100 in which the subject technology may be implemented, in accordance with one or more embodiments. Not all of the depicted components may be used in all embodiments, however, and one or more embodiments may include additional or different components than those shown in the figure. Variations in the arrangement and type of the components may be made without departing from the spirit or scope of the claims as set forth herein. Additional components, different components, or fewer components may be provided.

The network environment 100 may include a user device 102, an agent device 104, a server 106, and a database 108. The network 110 may communicatively (directly or indirectly) couple one or more of the user device 102, the agent device 104, the server 106, and the database 108. In one or more embodiments, the network 110 may be an interconnected network of devices that may include, or may be communicatively coupled to, the internet.

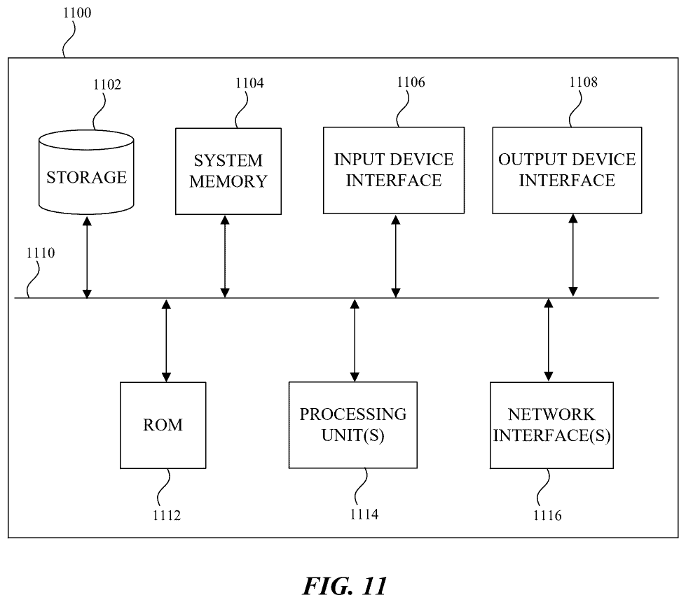

For explanatory purposes, the network environment 100 is illustrated in FIG. 1 as including the user device 102, the agent device 104, the server 106, and the database 108; however, the network environment 100 may include any number of electronic devices and/or any number of servers communicatively coupled to each other directly or via the network 110. In addition, the various systems of FIG. 1 may be, and/or may include all or part of, the electronic system discussed below with respect to FIG. 11.

The user device 102 may be under the control of a user of a service provided by an entity associated with the server 106, such as associated with and/or registered to a user account of the user. For example, the user may be a customer of the entity or may be a third-party with some connection to the customer of the entity, for example, the user may be a customer of the customer of the entity. In other examples, the relationship between the user and the entity may be that the user is an employee or subsidiary of the entity. In some instances, the user device 102 may interact directly or indirectly with the server 106 to obtain services from the server 106. With respect to the subject technology, the user of the user device 102 may utilize the user device 102 to contact the service provider via the server 106 regarding the service, thereby generating a contact event. The contact event may be, for example, a request for support to resolve a concern, upgrade a feature, change a service detail, request information, and so forth.

The agent device 104 may be under control of an agent of the entity providing the service to the user, such as associated with and/or registered to a user account of the agent. The agent device 104 may be used by the agent to receive the contact event from the user device 102. The agent device 104 may interact with the server 106 to send or receive information for the contact event. For example, the server 106 may be used to perform processes of the subject technology to associate contextual information with information from the contact event. The agent device 104 may be used by the agent to access the information for the contact event and the associated contextual information. In some implementations, the agent device 104 may be used to transcribe a phone call or chat session, send the transcript to the server 106 or database 108, and receive back from the server 106 or database 108, the transcript with contextual information relevant to the transcript associated with the transcript.

Each of the user device 102 and agent device 104 may be, for example, a wearable device (such as a watch, a band, and the like), a desktop computer, a portable computing device (e.g., a laptop computer), a point of service terminal, a smartphone, a peripheral device (e.g., a digital camera, headphones), a tablet device, or any other appropriate device that includes, for example, one or more wireless interfaces, such as WLAN radios, cellular radios, Bluetooth radios, Zigbee radios, near field communication (NFC) radios, and/or other wireless radios. In FIG. 1, by way of example, the user device 102 is depicted as a laptop computer and the agent device 104 is depicted as a workstation computer.

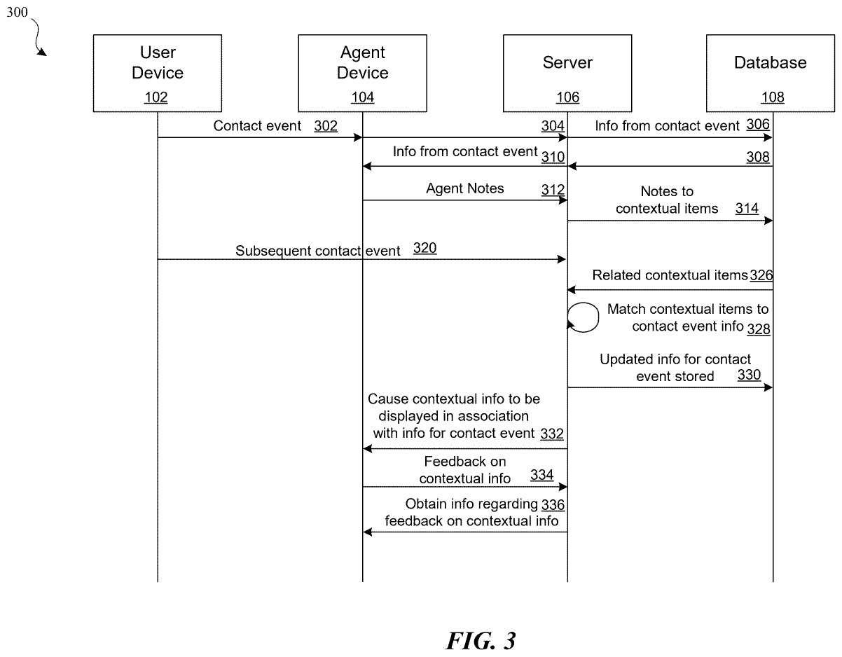

The server 106 may be and/or may include, for example, one or more servers that host or facilitate a process to perform operations related to the subject technology, such as associating contextual data from one or more other data sources with information in a contact event resulting from a contact between a user and an agent. For example, the server 106 may run processes to apply information from the contact event and related contextual data to a language model to determine whether the information in related contextual data has any relevant application to the information from the contact event, as is described further below with respect to FIG. 3. The server 106 may then provide the information from the contact event in association with the relevant information from the related contextual data to better equip the agent receiving the data to respond more efficiently and with less likelihood of error. Further, presenting the contextually relevant information in this manner reduces the amount of searches, querying, and general processing that needs to be performed by the agent's device to obtain the relevant data.

The server 106 may also be used to manage the contextual information and receive comments from agents which can be used to provide the contextual information. Thus, the server 106 may include logic and programming for performing the contextual linking to the information for a contact event and management of the contextual information, in accordance with the subject technology. The server 106 can provide messaging back to the user device 102 and/or agent device 104 which indicate that a requested action was successful or not. In some embodiments, the server 106 may be implemented as a service of one or more servers. Such one or more servers or the server 106 may be, and/or may include all or part of, the electronic system discussed below with respect to FIG. 11.

The database 108 may be and/or may include, for example, one or more servers that host or facilitate a database or datastore service that may be used by one or more entities, and may store and organize data related to the user device 102, the agent device 104, and/or the server 106. For example, the database 108 may store information for a contact event, contextual information related to a user, and user information to cross-reference. The database 108 may be implemented as service of one or more servers, such as the server 104, or one or more other servers. Such one or more other servers or the database 108 may each include all or part of the electronic system discussed below with respect to FIG. 11. The database 108 may utilize any suitable underlying datastore technology for implementing the record storing capabilities thereof.

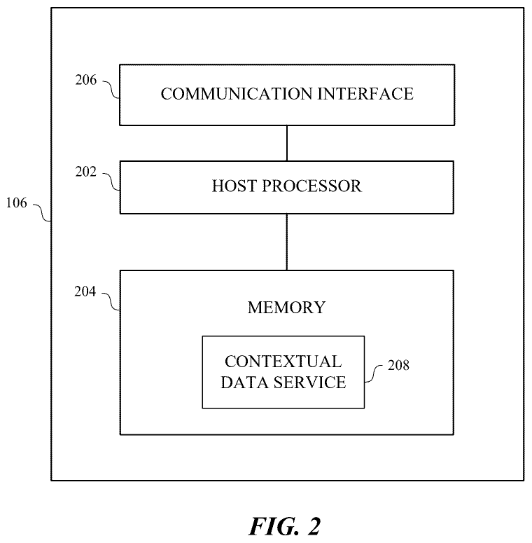

FIG. 2 depicts an example server 106 that may implement aspects of the subject technology, in accordance with one or more embodiments. For explanatory purposes, FIG. 2 is primarily described herein with reference to the server 106 of FIG. 1. However, this is merely illustrative, and features of the server of FIG. 2 may be implemented in any other electronic device for implementing the subject technology and/or any other server for implementing the subject technology, such as the database 108. Not all of the depicted components may be used in all embodiments, however, and one or more embodiments may include additional or different components than those shown in FIG. 2. Variations in the arrangement and type of the components may be made without departing from the spirit or scope of the claims as set forth herein. Additional components, different components, or fewer components may be provided.

The server 106 may include one or more of a host processor 202, a memory 204, and/or a communication interface 206. The host processor 202 may include suitable logic, circuitry, and/or code that enable processing data and/or controlling operations of the server 104. In this regard, the host processor 202 may be enabled to provide control signals to various other components of the server 106. The host processor 202 may also control transfers of data between various portions of the server 106. The host processor 202 may further implement an operating system or may otherwise execute code to manage operations of the server 106.

The memory 204 may include suitable logic, circuitry, and/or code that enable storage of various types of information such as received data, generated data, code, and/or configuration information. The memory 204 may include volatile memory (e.g., random access memory (RAM)) and/or non-volatile memory (e.g., read-only memory (ROM), flash, and/or magnetic storage). The memory 204 may include contextual data service 208 including executable programs, routines, and services that provide the functions described herein. The specific implemented contextual data service 208 may vary based on whether the memory 204 is implemented wholly or partially in the server 106 and/or other components of the system such as the database 108. The memory 204, for example, can include logic and/or programming instructions for implementing part or all of the subject technology corresponding to the contextual data service 208.

The communication interface 206 may include suitable logic, circuitry, and/or code that enables wired or wireless communication, such as between the user device 102, the agent device 104, the server 106, and/or the database 108. The communication interface 206 may include, for example, one or more of a Bluetooth communication interface, an NFC interface, a Zigbee communication interface, a WLAN communication interface, a USB communication interface, a cellular interface, or generally any communication interface.

In one or more embodiments, one or more of the host processor 202, the memory 204, the communication interface 206, and/or one or more portions thereof may be implemented in software (e.g., subroutines and code), may be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both.

FIG. 3 illustrates a lane flow diagram 300 which describes an implementation of a contextual item matching for a contact event, in accordance with some implementations. Optional implementation aspects are provided for in the description below, but which may be omitted in the flow diagram for the sake of simplicity. Although the discussion of the flow diagram 300 proceeds below describing the data flow between elements in a sequential manner, it should be understood that flow can be performed in parallel as appropriate or may flow out of the order described where the associated processes allow for the flow to differ. Although specific examples may be used to help elucidate the disclosure, it should be understood that the automated process management described below can be applied to any situation where a user would want to provide a database switchover or maintain a shadow backup of a database.

At elements 302, 304, and 306, a contact event originates from the user device 102. Element 302 illustrates the contact event being provided to the agent device 104; element 304 illustrates the contact event being provided to the server 106; and element 306 illustrates the contact event being provided to the database 108. For this contact event (and for all contact events), the contact event may follow any of these paths utilizing a contact channel selected by the user device 102. The agent device 104, the server 106, and the database 108, may each be associated with a particular entity. If the user device 102 corresponds to a phone, the user device 102 may call a switchboard (not illustrated) associated with the entity and the switchboard can route the call to the agent device 104 which the agent can use to interact with the user. The user device 102 can utilize an email communication channel and the email can be received by the entity at an email server (not specifically illustrated). The user device can use a chat communication channel to be routed to the agent device 104. Thus, in some situations where the contact event is directed to the agent device 104, the contact event may correspond to, for example, a phone call or a chat session between a user using the user device 102 and an agent using the agent device 104. In such situations, the agent device 104 may pass a copy of the communications resulting from the contact event to the server 106 and/or the database 108 (either directly or via the server 106) using a separate communication channel. In the situation where the contact event is directed to the server 106, the contact event may correspond to, for example, an email, an automated chat session, or a service request ticket, or the like. For example, a user of the user device 102 may send an email, submit a support ticket, engage in an automated chat session, and so forth, where the contact event is handled by the server 106. In such situations, the server 106 may store a copy of the communications resulting from the contact event at the database 108, and the agent device 104 may retrieve the communications using a separate communication channel than the one from the user device 102 to the server 106 and/or database 108.

At elements 308 and 310, information from the contact event is provided from the database 108 and/or the server 106 to the agent device 104. The information, for example, may be an email, a text exchange, a support ticket entry, an audio transcript, and so forth. The information from the contact event, for example, may represent communications from the user device 102 to the agent device 104, the server 106, and/or the database 108. The information may include integrated contextual information, such as described below. Elements 302, 304, 306, 308, and 310 may correspond to an asynchronous exchange between a user and an agent or may correspond to a contemporaneous exchange between the user and the agent, such as in a phone call or live chat session. Not shown, but contemplated is that information may also be provided back to the user device 102 from the agent device 104, such as a resolution to a concern or question provided as part of the contact event.

At element 312 the agent device 104 may provide agent notes to the server 106. The agent notes may result from the contact event. For example, the agent notes may include information learned which could be used again in a future similar situation. For example, suppose that a contact event resulted from a user complaining that they could not access a restricted webpage. If the agent resolved the issue by determining the user was incorrectly navigating to the restricted webpage, the agent may create an agent note explaining the issue and the resolution. Agent notes may also include general observations about the interactions between the user and the agent.

At element 314, the agent notes are converted to contextual items. In some implementations, the conversion and/or transforming may be an automated or semi-automated process. In other implementations, a manual process may be used for the agent or another representative of the entity corresponding to the agent device 104, server 106, and database 108 to create contextual item records for the agent notes. The contextual items may include, in some implementations, a database entry that includes information including an organization identifier to identify the organization to which the contextual item applies. Organizations may have several different accounts. The contextual item record may include a list of accounts of the organization for which the contextual item should apply. The organization id and account ids associated with the contextual item serve as an initial filter point for potential contextual items that can possibly be applied to communications in a contact event. If account ids are not supplied, then it can be considered that the contextual item applies to all accounts for that organization. The contextual item record also includes the text that will be displayed when the contextual information is provided, for example, which will be included in a pop out or in-line contextual information region of the communications related to a contact event. The contextual item record may optionally include detailed contextual information which, for example, may provide a user additional contextual information upon selecting a link displayed in the contextual information region.

The contextual item record also includes a description of events and/or situations for which the contextual information would be relevant. This description may include a list of keywords, tags, or natural language descriptions which would trigger the inclusion of the contextual information. For example, if the contextual information involves a situation where users cannot access a restricted webpage, then the description may include something like, “For access denied to restricted webpage while the user is logged into the system, a login loop can occur if the user accesses the restricted webpage via an unauthenticated link which forces a user logout for security purposes.” As will be described below, the subject technology can match such a description contextually with the communication information from a contact event to determine that the contextual information is relevant and should be included for use at the agent device 104. The contextual item record also includes a start date for when the contextual information is relevant and an end date. The end date ensures that the contextual item record stays fresh. For example, continuing with the restricted webpage example, if system designers alter the logic flow so that an unauthenticated link does not log out the user, then the contextual item record may no longer apply. If no one updates the corresponding contextual item record to indicate the end date early, the contextual item will eventually expire, removing a potential confusion that could occur if the contextual item is applied in a situation where the underlying design has obviated the concern that caused the contextual item to be applicable. Thus, the end date may be defaulted to a date that is 30, 60, or 90 days, etc. from the start date. In some instances, the end date may be prevented from being longer than a maximum date from the start date, such as 30, 60, or 90 days, etc., to ensure that the contextual item record stays fresh. In such instances, the start date can be updated upon a periodic review of the contextual item record which would allow the end date to be extended.

The contextual item record may be automatically prepopulated based on the agent notes provided. For example, the agent notes can serve as a basis for providing the description of events and/or situations for which the contextual information would be relevant. Further, the agent notes can be tied to a particular organization id and/or account ids which can be prepopulated into the contextual item record. A user interface can be provided for entering and/or updating contextual item records as a part of the conversion and/or transforming of the agent notes to the contextual item record. The agent that takes the agent note, for example, can be a general agent of the services provider associated with the agent device 104. Another agent that converts the agent notes into the contextual item record can be another type of agent more familiar with the organization which is receiving the support services. For example, the other agent may be an account manager with responsibility for handling services for a particular customer of the service provider. Continuing with the above example, the other agent may be a primary support agent for a company utilizing webpage services with technical expertise and detailed knowledge about the services utilized by the company, including the restricted webpage sections.

In addition to the process of adding contextual items to the contextual item record described above in elements 312 and 314, when a system condition associated with the services provider may affect one or more customers, a contextual item may be added to the contextual item record, in accordance with one or more implementations. The entry for the contextual item record can, for example, specify multiple organizations and/or accounts that the system condition may be associated with, or the entry can omit an organization identifier or account identifier such that the contextual item may be applied across all organizations and/or accounts of the services provider. The system condition, for example, may correspond to a service outage, a data security incident, a system wide notification for regulatory compliance, another incident, a change in an important policy, a planned service outage, an off hours customer service outage, a weekend-related event, a company holiday, or other condition that could also trigger context for one or more ongoing and future interactions. In some implementations, a system condition may trigger a contextual item record which has different effects depending on the organization and/or account of the services provider. For example, an organization and/or account may have a service level agreement with the services provider that specifies a certain uptime guarantee. When a system level concern causes a service level agreement to become in non-compliance, a contextual item record may be added related to the system condition, but specifically only for those organizations experiencing the non-compliant service level agreement condition. If the system condition continues, then additional determinations of non-compliance of the service level agreement can be made and additional contextual item records added for those organizations and/or accounts experiencing the non-compliant service level agreement condition after an additional time period. Other organization specific situations which may cause a contextual item record to be created may include, for example, a contact event in a related account, a contact event escalated in a related account, a user-specific incident where the user is specified as a contact in other organizations and/or accounts, a drop in health metric (such as a metric that indicates an increased number of failed network transactions related to the organization and/or accounts or a similar metric that may indicate a problem with the organization and/or account), an upcoming service contract expiration, and so forth.

In one or more implementations, flow can continue to element 326, as described below, such that when a contextual item is added to a contextual item record and stored in the database of contextual items, an update of any existing contact events can be initiated to include the contextual information in the record of contact events. This process may be helpful, for example, for system conditions which may affect multiple organizations and/or accounts. For example, a general contextual item may be included in the record of contact events so that an agent can be notified that the record was updated, and the agent can proactively contact the organization and/or account to notify the organization and/or account of the system level concern.

At element 320 a subsequent contact event may occur. Continuing with the above example, a user utilizing a user device 102 (which may be the same or different user device as that described above), may attempt to access a restricted webpage provided through the entity providing web services and associated with the agent device 104 and the server 106. An error may prompt the user of the user device 102 to initiate a contact event with the server 106. The contact event, for example, may be an email, a support ticket, a chat agent session, a phone call, etc. which can be routed eventually to the agent device 104. In some instances, for example, the agent device 104 may be involved immediately and the contact event may result in a contemporaneous exchange of information, for example, in a support call with a support agent. In such instances, a real-time transcription of the call can be provided to the server 106 or generated on the server 106, which can then be provided back to the agent device 104 at element 332, as described below. In some instances, however, the contact event may comprise an asynchronous communication that is provided to the server 106 along with information associating the contact event to a particular organization and/or one or more particular accounts associated with the organization.

At element 326, contextual item records may be retrieved from the database 108 and provided to the server 106 based on the organization id and/or account ids. At element 328, the content of the communications at the server 106 may be matched to contextual item records based on the description of events and/or situations for which the contextual information would be relevant found in each of the contextual item records retrieved from the database 108.

Matching may be accomplished by any appropriate process. For example, in one process, each of the description of events and/or situations for which the contextual information would be relevant may be provided to a large language model along with the communication content from the contact event. The large language model may be queried to identify, within the communication content, groups of words or phrases relevant to any of the keywords, tags, and/or descriptions of events and/or situations from each of the contextual item records. The large language model can be queried for example to return a ranking of the most relevant groups of words or phrases and the record id of the contextual item records which are relevant.

Utilizing a large language model may be beneficial because it can be used to relate ideas behind the keywords, tags, and/or descriptions of events and/or situations from the contextual item records to similar ideas behind the groups of words or phrases in the communication content. Continuing the previous example, a user may submit an email or support request that the user “cannot access a document on the website when they click a shortcut on their computer, but can access the document if they do so through a portal, and that when the shortcut is used account information must be re-entered.” While none of these words match the description from the example above, the concepts may match. The large language model, for example, may identify that the phrase, “shortcut is used account information must be re-entered,” as being relevant and linkable to a contextual record item that describes a condition where the user must access a restricted website through an authorized entry page rather than through a direct link for security purposes.

Matching may also be accomplished using keyword matching, heuristic rules, or semantic domains. For example, a set of rules can identify words in common from the communication content with words in common with the description, keywords, or tags in the contextual item records. When words in common are identified, words neighboring those words can be scored for relatedness to the description, keywords, or tags, and a phrase or grouping of words can be identified from the communication which are associated with the record id of the corresponding contextual item. Some special matching rules may also be used. For example, if a communication content includes account numbers, then those account numbers can be recognized using a rules-based approach and contextual item records including context specifically tied to account numbers can be associated with the listed account numbers.

Each matching process can match multiple phrases in the communication content. For a particular record id, the contextual item record can be matched to multiple phrases. In some implementations, only the most relevant phrase or grouping of words is selected for associating with a particular contextual item record. Some implementations may associate a particular contextual item record with additional groupings of words or phrases. Some implementations may match multiple contextual item records with multiple groupings of words or phrases. The number of matches may be limited in some instances to only the most relevant matches. In some instances, a relevance threshold may be used such that only matches meeting the relevance threshold may be associated with the one or more words or phrases in the communication content.

At element 330, the communication content of the contact event may be altered to store the record id of the contextual item record in association with the one, two, or three most relevant groups of words or phrases. In some implementations, the communication content of the content event may be altered to include additional generalized contextual information which may be displayed inline with the communication content when communication content is displayed. It may be cost effective to run the large language model query once per contact event, so storing the result as a permanent feature of the communication content can eliminate repeated queries to the large language model. Alternatively, in some implementations, contact events may be stored without the contextual information and it may be added each time the communication content is accessed. The communication content may be altered with the contextual information directly or may be altered by including a reference to the contextual item record, which may then be included when the communication content is displayed, for example, at the agent device 104.

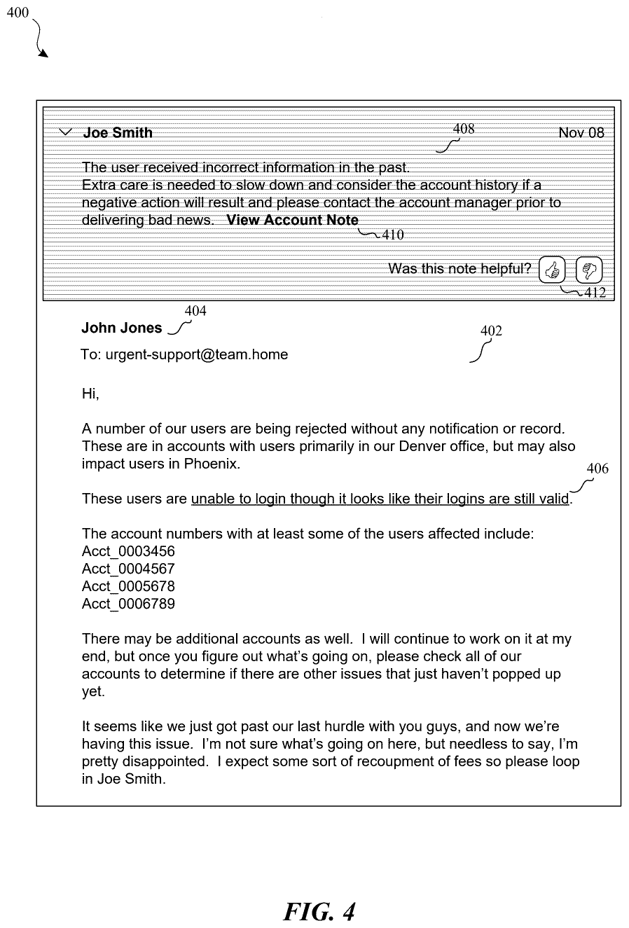

At element 332, an agent device 104 may access the support request and the server 106 and/or database 108 may provide the communication content of the contact event in association with the contextual information that was applied from the contextual item record. As demonstrated in further detail below with respect to FIGS. 4-6, the contextual information may be provided to the agent device in association with the communication content of the contact event. For example, if the communication content corresponds to an email, then one or more words from the email may be displayed with an indicator, such as an underline, font change, or highlighting, that context is available for those words. When a user engages with the indicated one or more words, such as by hovering a mouse pointer over the words or clicking the words, then the context associated with the one or more words may be displayed. Similarly, if general context is available which is related to the communication content and/or organization and/or accounts, then that general context can be displayed as well, such as by including the general context as an annotation before or inline with the communication content of the contact event.

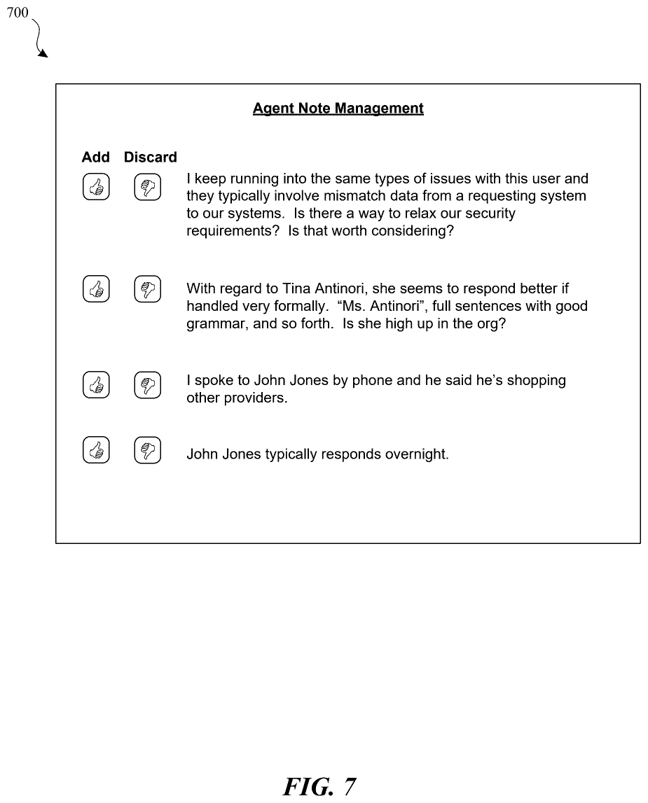

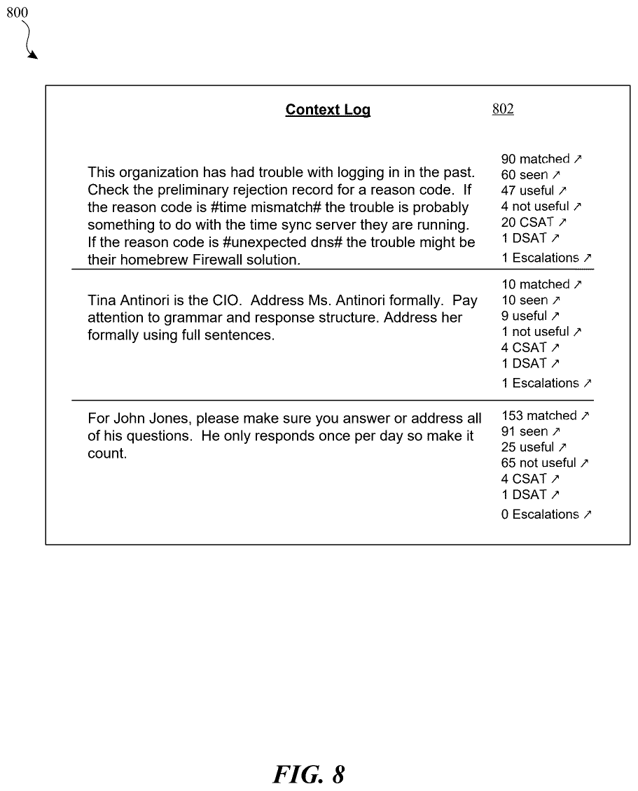

For example, turning briefly to FIGS. 4-6, FIGS. 4-6 (as well as FIGS. 7-8) include example user interfaces demonstrating aspects of the subject technology, in accordance with some implementations. It should be understood that the user interfaces depicted can be altered while still practicing aspects of the subject technology. The user interfaces displayed in FIGS. 4-6 (and in FIGS. 7-8) provide the advantage of including the contextual information in the same interface as the underlying communication as well as a visual representation tying certain aspects of the underlying communication to the contextual information. A reduction in computing resources, energy, storage, and network data transfer can be obtained by implementing the subject technology in user interfaces such as those depicted in FIGS. 4-8, at least because an agent accessing such user interfaces need not consult other sources for obtaining the information available in the user interfaces. Or in the case of user interfaces depicted in FIGS. 7-8, these both implement technological advantages by decreasing computer resource usage as well as support the various users of these systems to achieve the technological advantages present in the user interfaces, such as those depicted in FIGS. 4-6.

FIG. 4 illustrates a user interface 400 displaying an email 402 from a user 404 John Jones. The subject technology has underlined a portion of the text 406 to indicate that contextual information has been associated with the underlined portion of the text 406. In addition, general contextual information 408 has been provided by an agent Joe Smith for the immediate support agent to review in connection with the support request represented by the email 402. The general contextual information 408 may also include a link 410 to a more comprehensive set of account notes. The general contextual information 408 may also include a feedback mechanism 412 for the support agent to provide feedback on whether the general contextual information 408 was helpful or not. The general contextual information 408 may also include contextual information relating to any system outages that may have affected the organization and/or account associated with John Jones. As noted above, in some implementations, contextual information applicable on a broad basis may be added to the contact record even without a subsequent contact event. In such instances, the general contextual information 408 may include a separately entered general contextual information 408 including the system wide contextual information and another general contextual information 408 which may have been generated as a result of the subsequent contact event. The general contextual information, for example, can instruct an agent to address in the next contact, information regarding a system-wide incident or an incident for a related organization or account.

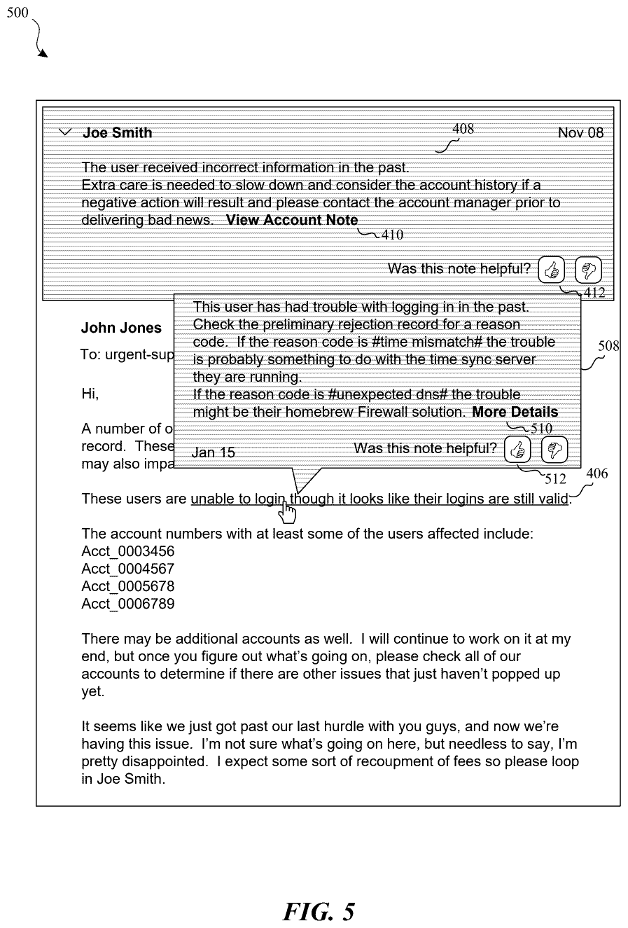

FIG. 5 illustrates a user interface 500 which corresponds to the user interface 400 after the support agent has positioned a pointer over or has otherwise selected the underlined portion of the text 406. For example, the pointer may hover over the underlined portion of the text 406 and the hover event may cause a contextual content bubble 508 or region to be overlaid on top of the communication content (e.g., the email 402) to provide contextual information related to the underlined portion of the text 406. The contextual content bubble 508 may also include a link 510 to more details related to the contextual information. The contextual content bubble 508 may also include a feedback mechanism 512 for the support agent to provide feedback on whether the contextual information in the contextual content bubble 508 was helpful or not.

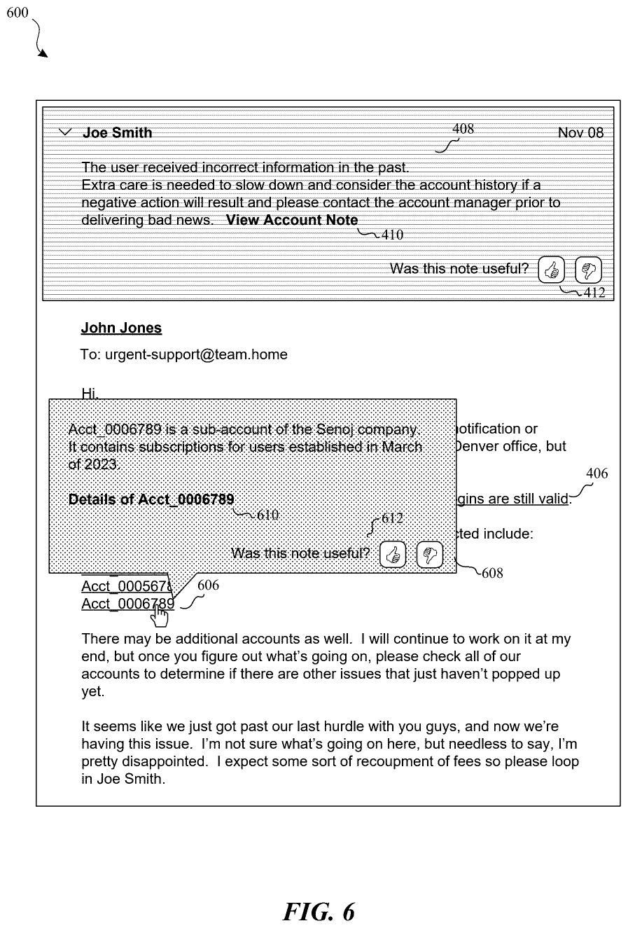

FIG. 6 illustrates a user interface 600 which may correspond to the user interface 400 and/or user interface 500 with additional features of the subject technology included. An underlined portion of the text 606 corresponds to an account number that the sender included in the communication content of the contact event. Contextual information can be included for account numbers in the contextual item records which may be matched to the account number listed in the communication content. The subject technology can include contextual information for accounts, for example, in a contextual content bubble 608 overlaid over the communication content (e.g., email). The contextual information for the account may include some aspects of the account which may be helpful for the support agent to know. A link 610 may also be provided which links to more detailed information for the account. The contextual content bubble 608 may also include a feedback mechanism 612 for the support agent to provide feedback on whether the contextual information in the contextual content bubble 608 was helpful or not.

At element 334, feedback on the contextual information may be provided, for example, via the feedback mechanism 412, 512, or 612 of FIGS. 4, 5, and 6, respectively, or another suitable feedback mechanism.

At element 336 the feedback which is aggregated and analyzed by the server 106 can be provided to the agent device 104. The feedback is discussed in greater detail with respect to FIG. 8.

FIG. 7 illustrates a user interface 700 which may correspond to an interface for a support agent to use to convert agent notes into contextual information. The agent notes can be provided to another support agent, such as an account or organization supervising agent who can decide whether to convert the agent notes into a contextual item record. This can be done, for example, in conjunction with element 314 described above. The supervising agent can select each agent note to generate a contextual item record for that comment. As an example, the first agent note can be selected to convert to a contextual item record. The text of the note can initially be included in the contextual item record as a description of the contextual item, which the supervising agent can edit. The supervising agent can specify the values for the other item values and thereby store the contextual item record. As another example, the second agent note can be selected to convert into a contextual item record. The text of the note can be associated with Tina Antinori, which can cause Tina's name in a communication content for a contact event to become linked to the contextual item that advises support agents to use formal communication style when interacting with Tina. As another example, the third agent note can be incorporated into a general context for the organization so that the support agent knows to handle the content event with care so that the organization is more likely to remain a customer of the service. As another example, the supervising agent may choose to discard the fourth agent note or convert the fourth agent note into a contextual item.

FIG. 8 illustrates a user interface 800 which may correspond to an interface including a context log 802 for a supervising agent to use to evaluate which contextual items are useful, which contextual items should be edited, or which contextual items may be deleted. The user interface 800 is only an example and any suitable layout and information may be used. The context log 802 may include a listing of contextual items and a statistical evaluation of each of the contextual items listed for the support agent's use in evaluating the effectiveness of the contextual item. The statistical information may include whether the contextual item was matched, whether the contextual item was selected, i.e., seen, whether the contextual item was deemed to be useful or not useful, whether the contextual item resulted in an increase in customer satisfaction (CSAT), whether the contextual item resulted in a decrease in customer satisfaction (DSAT) (for example, as part of a follow up survey with the customer), or whether any escalations were instituted based on the contextual item, such as a support agent calling on a supervisory agent to assist in addressing concerns raised in the contact event.

For example, the first item was deemed to be matched often and generally useful, resulting in increased customer satisfaction. The second item was not deemed to be matched as often, which may be expected if Tina Antinori does not send in many direct support requests via a contact event. The third item was matched often, but not deemed by the support agents to be very helpful, perhaps because they would address all of the concerns raised anyway.

The user interface 800 may be presented to the supervising agent to include only those context items which are near expiration. In such a manner, the supervising agent can quickly determine which items to update or refresh, which items to adjust and so forth.

As part of the review by the supervising agent, the supervising agent can recall communication content and associated contextual items. The supervising agent can review, for example, the one or more words that were selected to be associated with the contextual information. The supervising agent can adjust the one or more words that were selected as feedback to the large language model. For example, the supervising agent can revise the determination made by the large language model. In such instances, the large language model can be provided the updated determination which can be used to train the large language model to provide better selections. For example, the large language model can learn over time via input received from a supervising agent that groupings of five or six words are typically selected by the supervising agent. The large language model can subsequently demonstrate a preference for selecting groupings of five or six words.

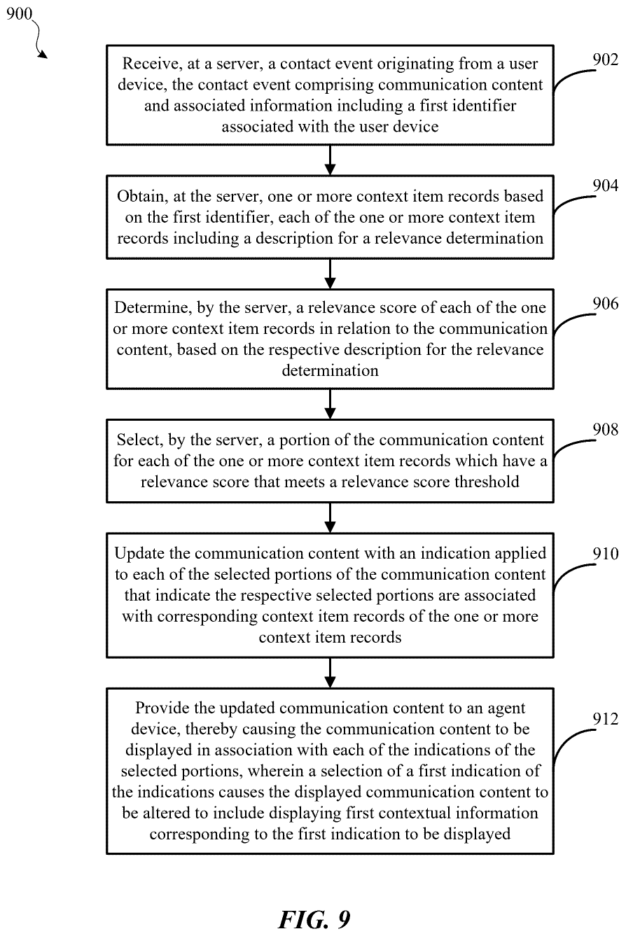

FIG. 9 illustrates a flow diagram of an example process 900 for providing at a server, such as the server 106, a mechanism for integrating a contextual data source into a display of a contact record, in accordance with the subject technology. For explanatory purposes, the process 900 is primarily described herein with reference to the user device 102, agent device 104, server 106, and database 108. However, the process 900 is not limited to these, and one or more blocks of the process 900 may be performed by one or more other by other suitable devices. Further, for explanatory purposes, the blocks of the process 900 are described herein as occurring sequentially or linearly. However, multiple blocks of the process 900 may occur in parallel. In addition, the blocks of the process 900 need not be performed in the order shown and/or one or more blocks of the process 900 need not be performed and/or can be replaced by other operations.

As shown in FIG. 9, block 902 of process 900 may include receiving, at a server, a contact event originating from a user device, the contact event having communication content and associated information including a first identifier associated with the user device. As noted above, the contact event may correspond, for example, to a user device engaging in a request for assistance from a sever associated with a service provided to the user device. The contact event may correspond to an email, a chat interaction, a support ticket, a phone call, or a text exchange, or the like. In some implementations, the contact event may correspond to a phone call and the communication content resulting from the contact event may be provided via a real-time transcription of the voice interaction. The first identifier associated with the user device may be an identifier of a user logged into the user device, the identifier of an organization associated with the user device, and/or the identifier of one or more accounts associated with the user device. For example, the organization may be an organization utilizing services provided from the same entity as the entity that provides the server. The services may be utilized through one or more accounts associated with the server. The services may be used by one or more authorized users. Identifiers from one or more of the organization, accounts, and/or authorized users may be used to determine a subset of available context item records which are scoped to the relevant organization and/or accounts.

As also shown in FIG. 9, block 904 of process 900 may include obtaining, at the server, one or more context item records based on the first identifier, each of the one or more context item records including a description for a relevance determination. The context item records may be obtained at the server, for example, from a data store or database of context item records. The first identifier identifying one or more of the organization, accounts, and/or authorized users may be used to determine a subset of available context item records which are scoped to the relevant organization and/or accounts. Each of the records may include the context, start date, expiration or end date, relevant account and/or organization identifiers, descriptions of the context, and other information, such as a relevance score required to use the context item record.

In some implementations, the one or more context item records may be obtained further based on an expiration date of the one or more context item records having not been reached. For example, if the expiration date is passed, even if the context item record may correspond to a particular organization, it may be omitted.

As further shown in FIG. 9, block 906 of process 900 may include determining, by the server, a relevance score of each of the one or more context item records in relation to the communication content, based on the respective description for the relevance determination. As explained above, the relevance score may be determined by utilizing a large language model in some implementations. Other implementations may utilize heuristics, keyword matching, or semantic domain spaces for determining relevance. In instances utilizing a large language model, the model can be provided the context item record descriptions for relevance determination as well as the communication content and queried to determine relevance scores for each of the available context item records with respect to the communication content. The query can further specify a request to identify a group of words or phrase with the highest relevance for each available context item record.

As also shown in FIG. 9, block 908 of process 900 may include identifying, by the server, a selection of the communication content for each of the one or more context item records which have a relevance score that meets a relevance score threshold. Block 908 provides that if the relevance meets a threshold for matching (which can be a default setting or specified for each context item record), then a selection of the communication content will be identified as being associated with the context item record (and the context provided within the context item record). The selection, for example, may correspond to one or more words or phrases that are related to the respective context item record, which is determined through the large language model. The large language model can be trained with feedback data to provide corrected selections which can be used to improve the selections made by the large language mode.

As further shown in FIG. 9, block 910 of process 900 may include updating the communication content with an indication applied to each of the identified selections of the communication content that indicate the respective identified selections are associated with corresponding context item records of the one or more context item records. The indication, for example, may correspond to encoding of the communication content that includes metadata or a digital alteration of the communication content that causes the identified selections to be displayed with a visual feature that makes clear that the selection is interactive to the user on the device on which it is displayed, e.g., an agent on an agent device. In some implementations, the metadata or other encoding can indicate that the selection be displayed as being underlined, in a different color, in a different font, in a different style (e.g., bold or italic), in a highlighted style, etc.

As also shown in FIG. 9, block 912 of process 900 may include providing the updated communication content to an agent device, thereby causing the communication content to be displayed in association with each of the indications of the identified selections, where a selection of each of the indications causes respective contextual information corresponding to a respective context item record to be displayed. The updated communication content, including any metadata or encoding information for the identified selection, can be provided to an agent device for display. Each of the identified selections can be linked to corresponding contextual information from the context item record. In some implementations, the identified selections can be linked to a record id of the context item record and the record id can be used to retrieve the context information stored in connection with the context item record. In some implementations, the context information can be retrieved at the previous block and included in the metadata or encoding so that displaying the context information does not require any further retrieval of information for displaying the context information in association with the identified selection of the communication content.

In some implementations, the updated communication content can be stored back in the data store or database so that if retrieved or updated with additional communication content from a follow on contact event, the context information does not have to be regenerated for the already processed communication content.

Process 900 may also include converting an agent note related to a prior contact event into a new context item record, the new context item record including a prefilled description for the relevance determination based on the agent note. For example, an agent may make a note based on a previous interaction with the client. The notes may be aggregated and presented to a supervisory agent, who can make a determination on which notes would be helpful for providing to the support agent in a subsequent support request originating from the user device.

Process 900 may also include providing, from the server and to a second agent device, a listing of context item records and statistical information representing feedback indicating whether each of the context item records is useful. The second agent device, for example, may correspond to a supervisory agent. The statistical information may provide information to the agent so that the agent can determine improvements, additions, or deletions with respect to the context item records. The statistical information may result, in part, from collecting feedback regarding the contextual items that are included in the communication content.

In some implementations, when the communication content is displayed at the agent device, the selection of the indication causes the respective contextual information corresponding to the respective context item record to be displayed in a pop up box overlaid on a display of the communication content. For example, a mouse hover over event, mouse click, mouse double click, and so forth may be detected over the indicated selection and a pop up box or tool tip-type box may be overlaid on the display of the communication client.

In one or more implementations, a first context item record of the one or more context item records corresponds to general context information associated with the first identifier, where the method further comprises: updating the communication content to insert the general context information associated with the first identifier in line with the communication content. The general context information may be inserted in the communication content in a manner similar to that described above with respect to the identified selection, except the metadata or encoded data can indicate a placement of the general context information before, for example, the last communication in the communication content.

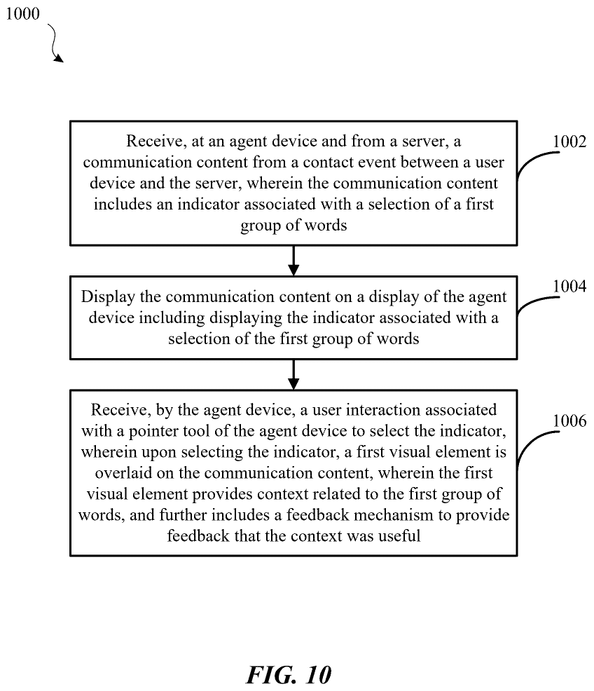

FIG. 10 illustrates a flow diagram of an example process 1000 for displaying at a device, such as the agent device 104, an integrated contextual data source in a display of a contact record, in accordance with the subject technology. For explanatory purposes, the process 1000 is primarily described herein with reference to the user device 102, agent device 104, server 106, and database 108. However, the process 1000 is not limited to these, and one or more blocks of the process 1000 may be performed by one or more other by other suitable devices. Further, for explanatory purposes, the blocks of the process 1000 are described herein as occurring sequentially or linearly. However, multiple blocks of the process 1000 may occur in parallel. In addition, the blocks of the process 1000 need not be performed in the order shown and/or one or more blocks of the process 1000 need not be performed and/or can be replaced by other operations.

As shown in FIG. 10, block 1002 of process 1000 may include receiving, at an agent device and from a server, a communication content from a contact event between a user device and the server, where the communication content includes an indicator associated with a selection of a first group of words. An agent device may receive communication content from a contact event that has been processed and altered to include context information integrated in the communication content. An indicator, such as a different font style, font typeface, font size, highlighting, and so forth may be used with respect to a selection of a first group of words that indicates that selecting those first group of words will provide a pop-up of contextual information.

As also shown in FIG. 10, block 1004 of process 1000 may include displaying the communication content on a display of the agent device including displaying the indicator associated with a selection of the first group of words. The communication content received at block 1002 may be displayed at the agent device in association with the indicator for the first group of words.

As further shown in FIG. 10, block 1006 of process 1000 may include engaging, by the agent device, a pointer tool of the agent device to select the indicator, where upon selecting the indicator, a first visual element is overlaid on the communication content, where the first visual element provides context related to the first group of words, and further includes a feedback mechanism to provide feedback that the context was useful. A user at the agent device, for example, may hover over, click, or double click the indicator using a pointer tool. When the indicator is selected a first visual element may be overlaid on the communication content, such as a pop-up box, that provides contextually relevant information for the first group of words.

Process 1000 may include additional implementations, such as any single implementation or any combination of implementations described below and/or in connection with one or more other processes described elsewhere herein. In one implementation, the communication content further includes general contextual information associated with the user device, where the general contextual information is provided in line with the communication content. The communication content may include general contextual information, for example, related to the client, organization, accounts, etc. corresponding to the communication content or contact event. In some implementations, the general contextual information may be one color while other contextual information associated with a selection of words may be another color.

In some implementations, the communication content corresponds to an email, a chat interaction, a support ticket, a phone call, or a text exchange. In one or more implementations, the first visual element may also include a link to a webpage, a start date for the context included in the first visual element, or an end date included in the first visual element. In another implementation, the communication content includes a second indicator associated with a second selection of a second group of words, where the second group of words includes an account number associated with the user device, the method further includes displaying the communication content on the display of the agent device including displaying the second indicator associated with the second group of words; engaging by the agent device, the pointer tool of the agent device to select the second indicator, where upon selecting the second indicator, a second visual element is overlaid on the communication content, where the second visual element provides context related to the first group of words. Account numbers or other particular identifiers, such as names, phone numbers, etc., for example, may use pattern matching to obtain and display contextual information specific to those identifiers. The contextual information can be provided in a context item record in a manner consistent with that discussed above and linked to an identified selection of the communication content.

FIG. 11 depicts an example electronic system 1100 with which aspects of the present disclosure may be implemented, in accordance with one or more embodiments. The electronic system 1100 can be, and/or can be a part of, any device or server for generating the features and processes described in reference to FIGS. 1-3 and 9-10, including but not limited to a laptop computer, tablet computer, smartphone, and wearable device (e.g., smartwatch, fitness band). The electronic system 1100 may include various types of computer-readable media and interfaces for various other types of computer-readable media. The electronic system 1100 includes one or more processing unit(s) 1114, a persistent storage device 1102, a system memory 1104 (and/or buffer), an input device interface 1106, an output device interface 1108, a bus 1110, a ROM 1112, one or more processing unit(s) 1114, one or more network interface(s) 1116, and/or subsets and variations thereof.

The bus 1110 collectively represents all system, peripheral, and chipset buses that communicatively connect the numerous internal devices of the electronic system 1100. In one or more embodiments, the bus 1110 communicatively connects the one or more processing unit(s) 1114 with the ROM 1112, the system memory 1104, and the persistent storage device 1102. From these various memory units, the one or more processing unit(s) 1114 retrieves instructions to execute and data to process in order to execute the processes of the subject disclosure. The one or more processing unit(s) 1114 can be a single processor or a multi-core processor in different embodiments.

The ROM 1112 stores static data and instructions that are needed by the one or more processing unit(s) 1114 and other modules of the electronic system 1100. The persistent storage device 1102, on the other hand, may be a read-and-write memory device. The persistent storage device 1102 may be a non-volatile memory unit that stores instructions and data even when the electronic system 1100 is off. In one or more embodiments, a mass-storage device (such as a magnetic or optical disk and its corresponding disk drive) may be used as the persistent storage device 1102.

In one or more embodiments, a removable storage device (such as a floppy disk, flash drive, and its corresponding disk drive) may be used as the persistent storage device 1102. Like the persistent storage device 1102, the system memory 1104 may be a read-and-write memory device. However, unlike the persistent storage device 1102, the system memory 1104 may be a volatile read-and-write memory, such as RAM. The system memory 1104 may store any of the instructions and data that one or more processing unit(s) 1114 may need at runtime. In one or more embodiments, the processes of the subject disclosure are stored in the system memory 1104, the persistent storage device 1102, and/or the ROM 1112. From these various memory units, the one or more processing unit(s) 1114 retrieves instructions to execute and data to process in order to execute the processes of one or more embodiments.

The bus 1110 also connects to the input device interfaces 1106 and output device interfaces 1108. The input device interface 1106 enables a user to communicate information and select commands to the electronic system 1100. Input devices that may be used with the input device interface 1106 may include, for example, alphanumeric keyboards, touch screens, and pointing devices. The output device interface 1108 may enable the electronic system 1100 to communicate information to users. For example, the output device interface 1108 may provide the display of images generated by electronic system 1100. Output devices that may be used with the output device interface 1108 may include, for example, printers and display devices, such as a liquid crystal display (LCD), a light emitting diode (LED) display, an organic light emitting diode (OLED) display, a flexible display, a flat panel display, a solid-state display, a projector, or any other device for outputting information. One or more embodiments may include devices that function as both input and output devices, such as a touchscreen. In these embodiments, feedback provided to the user can be any form of sensory feedback, such as visual feedback, auditory feedback, or tactile feedback; and input from the user can be received in any form, including acoustic, speech, or tactile input.

The bus 1110 also couples the electronic system 1100 to one or more networks and/or to one or more network nodes through the one or more network interface(s) 1116. In this manner, the electronic system 1100 can be a part of a network of computers (such as a local area network, a wide area network, an intranet, or a network of networks, such as the internet). Any or all components of the electronic system 1100 can be used in conjunction with the subject disclosure.

Embodiments within the scope of the present disclosure can be partially or entirely realized using a tangible computer-readable storage medium (or multiple tangible computer-readable storage media of one or more types) encoding one or more computer-readable instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more embodiments, the tangible computer-readable storage medium can be directly coupled to a computing device, while in other embodiments, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessors or multi-core processors that execute software, one or more embodiments are performed by one or more integrated circuits, such as ASICs or FPGAs. In one or more embodiments, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way), all without departing from the scope of the subject technology.

It is understood that any specific order or hierarchy of blocks in the processes disclosed is an illustration of example approaches. Based upon design preferences, it is understood that the specific order or hierarchy of blocks in the processes may be re-arranged, or that all illustrated blocks be performed. Any of the blocks may be performed simultaneously. In one or more embodiments, multitasking and parallel processing may be advantageous. Moreover, the separation of various system components in the embodiments described above should not be understood as requiring such separation in all embodiments, and it should be understood that the described program components and systems can generally be integrated together into a single software product or packaged into multiple software products.

As used in this specification and any claims of this application, the terms “base station,” “receiver,” “computer,” “server,” “processor,” and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refers to only A, only B, or only C; any combination of A, B, and C; and/or at least one of each of A, B, and C.

The predicate words “configured to,” “operable to,” and “programmed to” do not imply any particular tangible or intangible modification of a subject, but, rather, are intended to be used interchangeably. In one or more embodiments, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, one or more implementations, an embodiment, the embodiment, another embodiment, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration.” Any embodiment described herein as “exemplary” or as an “example” is not necessarily to be construed as preferred or advantageous over other embodiments. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

1. A method comprising:
receiving, at a server, a contact event originating from a user device, the contact event comprising communication content and associated information including a first identifier associated with the user device;
obtaining, at the server, one or more context item records based on the first identifier, each of the one or more context item records including a description for a relevance determination;
determining, by the server, based on the respective description for the relevance determination, a relevance score of each of the one or more context item records in relation to the communication content by submitting, to a large language model, the one or more context item records and the communication content together with a query to provide relevance scores for relevant groupings of words;
selecting, by the server, a portion of the communication content for each of the one or more context item records which have a relevance score that meets a relevance score threshold;
updating the communication content with an indication applied to each of the selected portions of the communication content that indicate the respective selected portions are associated with corresponding context item records of the one or more context item records; and
providing the updated communication content to an agent device, thereby causing the communication content to be displayed in association with each of the indications of the selected portions, wherein a selection of a first indication of the indications causes the displayed communication content to be altered to include displaying first contextual information corresponding to the first indication to be displayed.

2. The method of claim 1, wherein obtaining the one or more context item records is further based on an expiration date of the one or more context item records having not been reached.

3. The method of claim 1, further comprising:
converting an agent note related to a prior contact event into a new context item record, the new context item record including a prefilled description for the relevance determination based on the agent note.

4. The method of claim 1, further comprising:
providing, from the server and to a second agent device, a listing of context item records and statistical information representing feedback indicating whether each of the context item records is useful.

5. The method of claim 1, wherein the selection of the first indication causes the first contextual information to be displayed in a pop up box overlaid on a display of the communication content.

6. The method of claim 1, wherein the contact event corresponds to an email, a chat interaction, a support ticket, a phone call, or a text exchange.

7. The method of claim 1, wherein the communication content is provided via a real-time transcription of a voice interaction.

8. The method of claim 1, wherein a first context item record of the one or more context item records corresponds to general information associated with the first identifier, wherein the method further comprises:
updating the communication content to insert the general information associated with the first identifier in line with the communication content.

9. (canceled)

10. The method of claim 1, wherein the portion of the communication content corresponds to a grouping of words from the communication content, wherein selecting the portion of the communication content comprises querying a large language model to obtain the grouping of words in association with a respective context item record, wherein the large language model was previously trained on groupings of words to indicate a system preference for a number of words in the grouping of words.

11. A method comprising:
receiving, at an agent device and from a server, a communication content from a contact event between a user device and the server, wherein the communication content includes an indicator associated with a selection of a first group of words;
displaying the communication content on a display of the agent device including displaying the indicator associated with a selection of the first group of words; and
receiving, by the agent device, a user interaction associated with a pointer tool of the agent device to select the indicator, wherein upon selecting the indicator, a first visual element is overlaid on the communication content, wherein the first visual element provides context related to the first group of words, and further includes a feedback mechanism to provide feedback that the context was useful.

12. The method of claim 11, wherein the communication content further includes general contextual information associated with the user device, wherein the general contextual information is provided in line with the communication content.

13. The method of claim 11, wherein the first group of words was identified based on a relevance determination, and wherein the communication content corresponds to an email, a chat interaction, a support ticket, a phone call, or a text exchange.

14. The method of claim 11, wherein the first visual element includes a link to a webpage, a start date for the context included in the first visual element, or an end date included in the first visual element.

15. The method of claim 11, wherein the communication content includes a second indicator associated with a second selection of a second group of words, wherein the second group of words includes an account number associated with the user device, the method further comprising:
displaying the communication content on the display of the agent device including displaying the second indicator associated with the second group of words;
engaging by the agent device, the pointer tool of the agent device to select the second indicator, wherein upon selecting the second indicator, a second visual element is overlaid on the communication content, wherein the second visual element provides context related to the first group of words.

16. A device comprising:
a computer-readable medium;
one or more processors configured to perform operations comprising:
receiving, at the device, a contact event originating from a user device, the contact event comprising communication content and associated information including a first identifier associated with the user device;
obtaining, at the device, one or more context item records based on the first identifier, each of the one or more context item records including a description for a relevance determination;
determining, by the device, based on the respective description for the relevance determination, a relevance score of each of the one or more context item records in relation to the communication content by submitting, to a large language model, the one or more context item records and the communication content together with a query to provide relevance scores for relevant groupings of words;
identifying, by the device, a selection of the communication content for each of the one or more context item records which have a relevance score that meets a relevance score threshold;
updating the communication content with an indication applied to each of the identified selections of the communication content that indicate the respective identified selections are associated with corresponding context item records of the one or more context item records; and
providing the updated communication content to an agent device, thereby causing the communication content to be displayed in association with each of the indications of the identified selections, wherein a selection of each of the indications causes respective contextual information corresponding to a respective context item record to be displayed.

17. The device of claim 16, wherein obtaining the one or more context item records is further based on an expiration date of the one or more context item records having not been reached.

18. The device of claim 16, wherein the selection of the indication causes the respective contextual information corresponding to the respective context item record to be displayed in a pop up box overlaid on a display of the communication content.

19. The device of claim 16, wherein a first context item record of the one or more context item records corresponds to general information associated with the first identifier, wherein the one or more processors are further configured to perform operations comprising:
updating the communication content to insert the general information associated with the first identifier in line with the communication content.

20. (canceled)

21. The method of claim 1, further comprising: storing the updated communication content in a data store, wherein the updated communication content is stored in the data store such that the contextual information associated with the selected portions does not have to be regenerated when the communication content is subsequently accessed.

22. The device of claim 16, wherein the operations further comprise: storing the updated communication content in a data store, wherein the updated communication content is stored in the data store such that the contextual information associated with the identified selections does not have to be regenerated when the communication content is subsequently accessed, and wherein the large language model is trained with feedback data to provide corrected identified selections of the communication content, the feedback data based on input from a supervising agent adjusting the identified selections.
